(19) United States
(12) Patent Application Publication
(10) Pub. No.: US 2007/0265930 A1
(43) Pub. Date: Nov. 15, 2007

(54) Usability by offering the possibility to change viewing order in a navigation panel

(76) Inventor: Julia Mohr, Edingen-Neckarhausen (DE)

Correspondence Address: KENYON & KENYON LLP, ONE BROADWAY, NEW YORK, NY, 10004, US

(21) Appl. No.: 11/412,336

(22) Filed: Apr. 26, 2006

(51) Int. Cl. G06Q 30/00

(52) U.S. Cl. 705/26

(57) ABSTRACT

A method, graphical user interface, system, and a computer readable medium containing instructions that when executed result in a performance of a method for displaying an enterprise portal, displaying a navigation panel in the enterprise portal, wherein the navigation panel has at least one window pane, detecting a first position of a first window pane, detecting an input signal to drag-and-drop the first window pane to a second position, and displaying the first window pane in the second position.

### REFERENCE TO RELATED APPLICATION

This application is related to co-pending, commonly assigned, U.S. patent application Ser. No.______ for “Improving Portal Page Personalization Offering a Direct Manipulative Window Arrangement Functionality,” filed on the same day as this application.

### BACKGROUND

Software integration tools currently provide methods to utilize Enterprise Resource Planning (ERP) systems, which allow for the integration and automation of business practices, while providing portals to deliver content and functionality to users. Content can be displayed to a user based on the user's role in the enterprise or they can be tailored to the specific user by the portal administrator. Pre-defined portal templates can be selected for individual users by portal administrators, chosen by the users, or automatically selected due to a user's role. The portal views contain window panes that are specific to the user, typically based on that user's tasks or clearance to access certain types of content. Portals also contain a navigation panel, wherein the navigation panels also have window panes that have embedded functionality, data content, and navigational links. Like the specific window panes and navigation panel window panes that are pre-selected, the positioning and layout of the window panes is also pre-selected and defined for a user. Moreover, even if the location of a window pane can be changed, it requires maneuvering through various menus to later save a new layout.

### BRIEF DESCRIPTION OF THE DRAWINGS

FIG. 1 depicts a possible configuration of a system capable of using an embodiment of the invention.

FIG. 2 depicts an example display of an enterprise portal.

FIG. 3 depicts an example embodiment of the enterprise portal that utilizes a drag-and-drop functionality to alter the positioning of window panes in the navigation panel.

FIG. 4 depicts the dropping action of a drag-and-drop of a window pane.

FIG. 5 depicts an example embodiment that automatically shifts the window panes vertically to eliminate the white space in-between window panes and keeps all the white space at the bottom of the navigation panel.

FIG. 6 depicts an example embodiment where a window pane, in this example the same portal favorites pane, is dragged to overlap two other window panes in the navigational panel.

FIG. 7a depicts an example embodiment where the enterprise portal navigation panel automatically adjust to shift the window panes to eliminate overlap.

FIG. 7b depicts an alternative embodiment with horizontal drag-and-drop and automatic resizing.

FIG. 7c depicts a window pane that is resized after it has moved horizontally to match with the width of another pane.

FIG. 8 depicts an example embodiment where a window pane can be “hidden” if the window pane is dragged outside of the navigation panel region.

FIG. 9 depicts an example embodiment where multiple panes can be drag-and-dropped.

FIG. 10 depicts the multiple panes dragged to overlap another pane.

FIG. 11 depicts an embodiment where the panes automatically shift panes to eliminate horizontal and vertical white space.

FIG. 12 depicts an example embodiment where the panes that are selected are not contiguous.

FIG. 13 depicts an example embodiment where the group of panes is shifted down below another pane.

FIG. 14 depicts an embodiment where the navigation panel automatically eliminates the white spaces appearing between the panes.

FIG. 15 depicts an example logic that may be used to implement an embodiment of the present invention.

### DETAILED DESCRIPTION

E-business software integration tools utilize ERP back-end systems to aid in organizing business content and processes while using adaptable displays to provide user friendly and reusable front-end portals to users. The ERP functionality can aid in business activities, such as manufacturing, logistics, customer relationship management (CRM), supply chain management (SCM), inventory management, quality management, human resources management, strategic management, e-procurement, business intelligence, product lifecycle management, etc. In order to utilize the assorted back-end functionality without requiring new training for the user interfaces, enterprise portals utilize templates to provide similar layouts with a look-and-feel that users are accustomed to. These layouts derive from the same types of pre-defined templates.

The Enterprise Portals are front-end portals, which are typically for intranets but can also access internet data and may be a web-based cross-application platform that can access data and utilize processes from multiple servers, languages and technologies.

Among the types of back-end systems that an enterprise portal may access are packaged applications, eBusiness XML exchanges, messaging systems, proprietary formats, application servers, legacy databases, data warehouses, relation and nonrelational databases, screen-based systems, transaction systems, 3GL and 4GL applications, etc. The display may be presented on an application but is typically a web-based display. The enterprise portal may provide various types of windows or window panes, such as a navigation panel or a main content window. The navigation portal or main content window may contain window panes with embedded functionality, such as integrated views (iViews) of backend systems. The iViews may link to content data that may be displayed in the main content window or other window panes of the enterprise portal, open new windows to display new content or functionality, process business data, provide navigation links, run applications in a new window, display portal favorites, search the enterprise portal, etc. The iViews can support access to multiple types of ERP applications and databases of remote systems, as well as functionality on the previously mentioned back-end systems. Moreover, due to the nature of the enterprise portal, much of the content data may be business data.

The enterprise portal layouts and positioning of window panes are derived from templates but are tailored for a specific user or a specific role by a portal administrator. A role can be procedural, for example an executive officer versus an employee, or functional, for example a human resource manager versus a supply chain manager. The portal administrator may tailor one type of enterprise portal for various roles based on the tasks that a role performs or on the level of access to data or functions.

An advantage of an embodiment of the present invention is to not only be able to provide a user with pre-defined template portals but also to allow the individual users to alter the specific appearance of the portals by drag-and-dropping window panes into alternate locations within a navigation panel. An embodiment of the invention may display an enterprise portal, display a navigation panel in the enterprise portal (wherein the navigation panel has at least one window pane), detect a first position of a first window pane, detect an input signal to drag-and-drop the first window pane to a second position, and display the first window pane in the second position.

An embodiment of the present invention may also have a system comprising an arrangement for displaying an enterprise portal, an arrangement for displaying a navigation panel in the enterprise portal (wherein the navigation panel has at least one window pane), an arrangement for detecting a first position of a first window pane, an arrangement for detecting an input signal to drag-and-drop the first window pane to a second position, and an arrangement for displaying the first window pane in the second position. The arrangement for displaying an enterprise portal, a navigation panel, and a window pane in the second position, could be an LCD display on a laptop or handheld device, a CRT or LCD monitor, a television, etc. The arrangement for detecting an input signal could be a mouse, mouse pen, trackball, keyboard, etc. that is connected to a processor in a computing device. The arrangement for detecting the positions of a window pane could be any computing device with a processor, such as a laptop, desktop, handheld device, server, etc. Reference to the navigation panel within the enterprise portal refers only to the window panes and iViews in the navigation panel and does not include window panes outside the region of the navigation panel in a portal page.

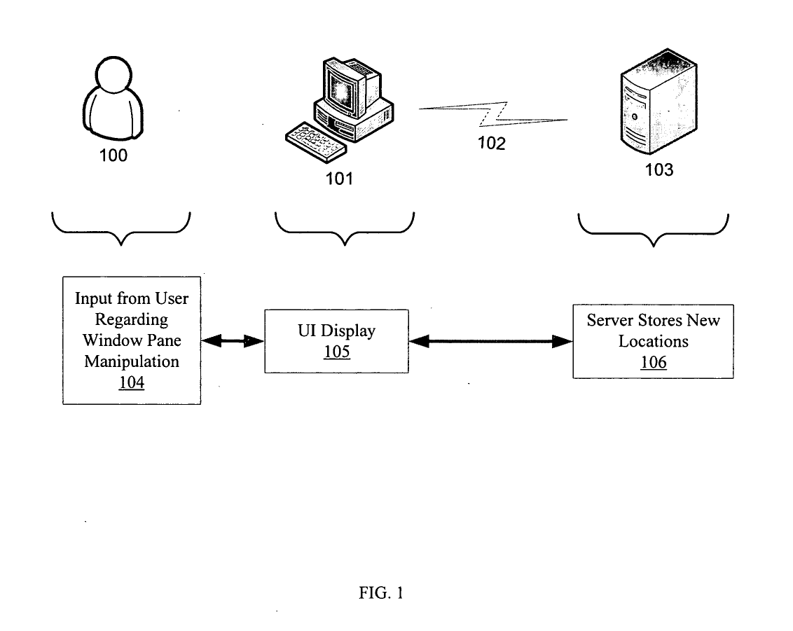

FIG. 1 depicts a possible configuration of a system capable of using an embodiment of the invention. A user 100 inputs a signal that indicates to the enterprise portal that the user is manipulating the position of a window pane 104, such as an iView. The enterprise portal user interface (UI) display 105 is presented to the user by a computing device 101. The computing device 101 takes the input 104 and the embodiment processes the user's change in location of a selected window pane or window panes and alters the user interface display to reflect the user's changes. The computing device may transmit the newly altered user interface display location to a server 103 via a communication medium 102. The server or multiple servers 103 may store the data 106 and attribute these changes either to the specific user or to the role of the specific user. The computing device 101 may be any hardware that has processing or computational capability, such as a laptop, handheld device, etc. The communication medium 102 may be either intranet or internet and over a wireless or wired communication (e.g. ethernet cable). The server 103 may hold database information or contain back-end applications, and one may distribute the functional modules or storage modules of an embodiment across one or more server computers 103 as appropriate.

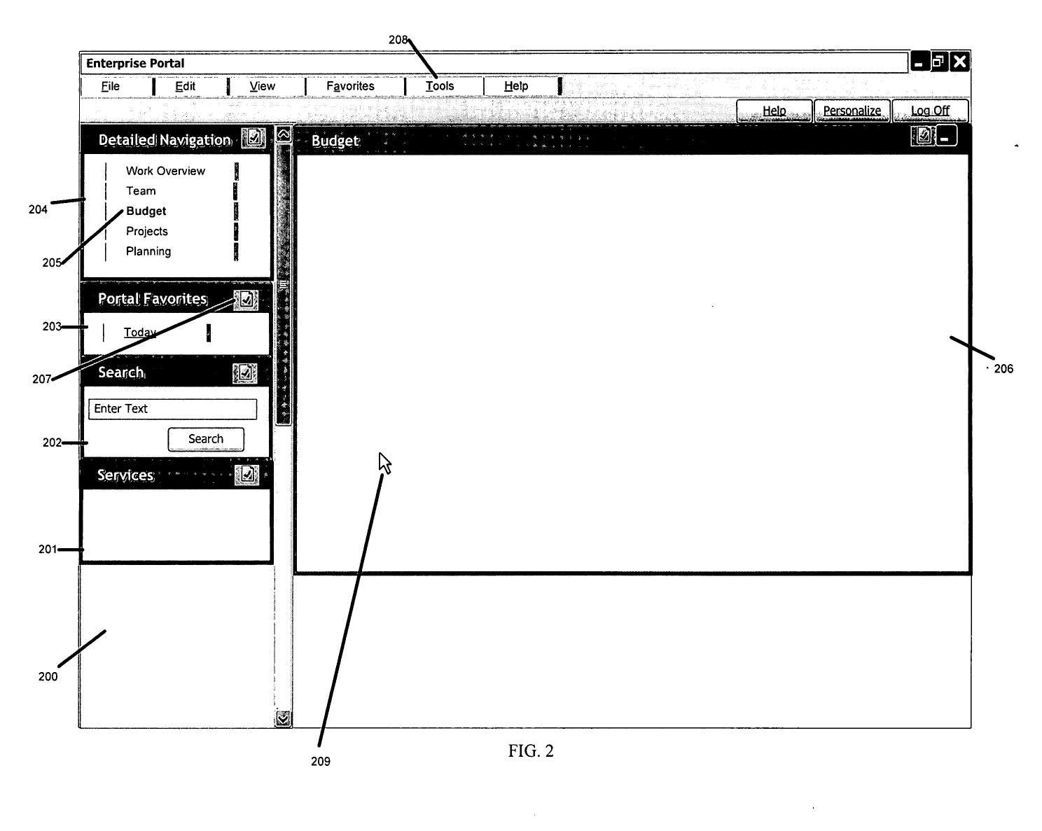

FIG. 2 depicts an example display of an enterprise portal. On the left side is a navigation panel 200 which contains several window panes, many of which are integrated views (iViews) of backend systems which can link to content data or functional applications. For example, a services window pane 201 could contain a link to a functional service or could contain buttons for the actual service itself. A search window 202 could search through the various databases on the backend servers of the enterprise portal. A portal favorites window pane 203 could list favorite links of the day, a history of links, or general favorites links. The detailed navigation window 204 could display the primary content and application that is displayed in the main window 206. In this particular example, the “budget” 205 information is displayed in the main window. To change information in the layout of the enterprise portal a user may access the “tools” menu 208 in order to change properties to the portal. Alternatively, the user may click on properties 207 of the various window panes to access menu options to change the layout of a navigation panel. However, using drag-and-drop with an input from the cursor 209, a user may manipulate the window panes without having to access menus.

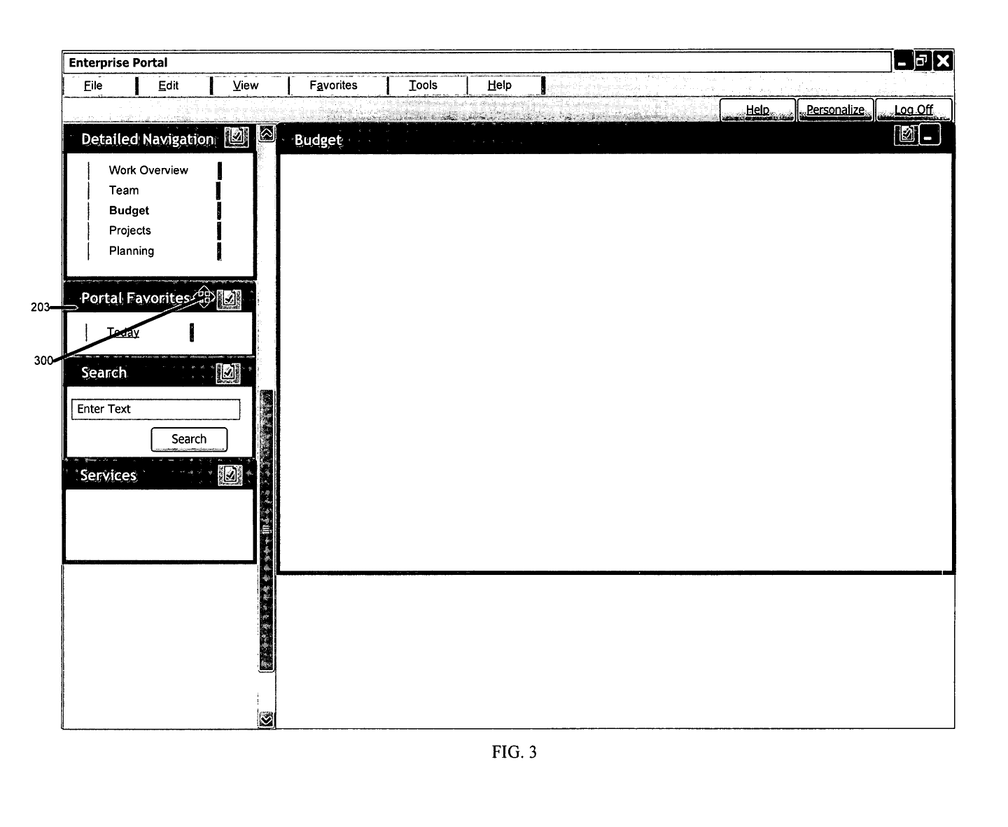

FIG. 3 depicts an example embodiment of the enterprise portal that utilizes a drag-and-drop functionality to alter the positioning of window panes in the navigation panel. The application would indicate to the user that the window pane is ready to be moved. For example, if the portal favorites pane 203 was the window pane that a user wanted to move, the user could position the cursor over the window pane. When the cursor is in a position that could move the window pane the portal could provide an indicia, such as having the cursor change its appearance to that of a crosshair 300. Alternatively, the window pane could be highlighted. The user could proceed to drag the window pane around the navigation panel.

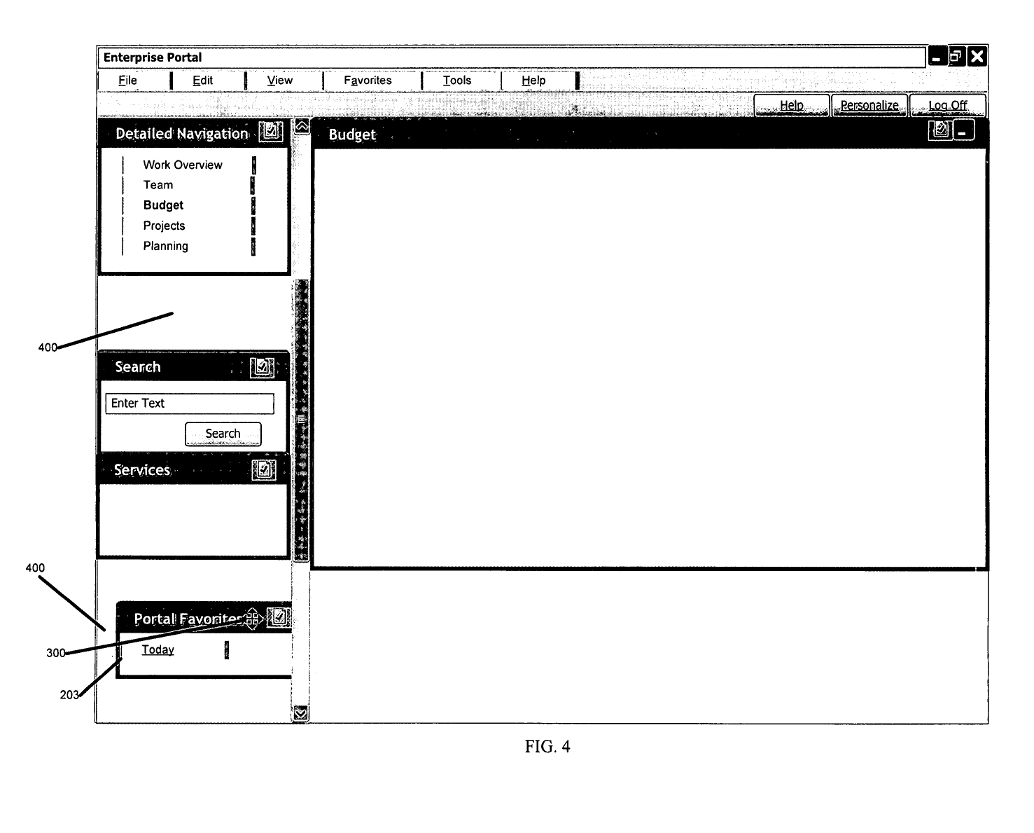

FIG. 4 depicts the dropping action of a drag-and-drop of a window pane. The enterprise portal would register the new location of the window pane, in this case the portal favorites pane 203, when the user deselects the pane. The positioning of the pane would follow the cursor position. In some embodiments of the enterprise portal, the position of the pane may stay exactly where the user left the pane thus leaving a significant amount of white space 400 in-between window panes. However, in other embodiments, the pane may automatically shift horizontally so that it is aligned with the navigation panel.

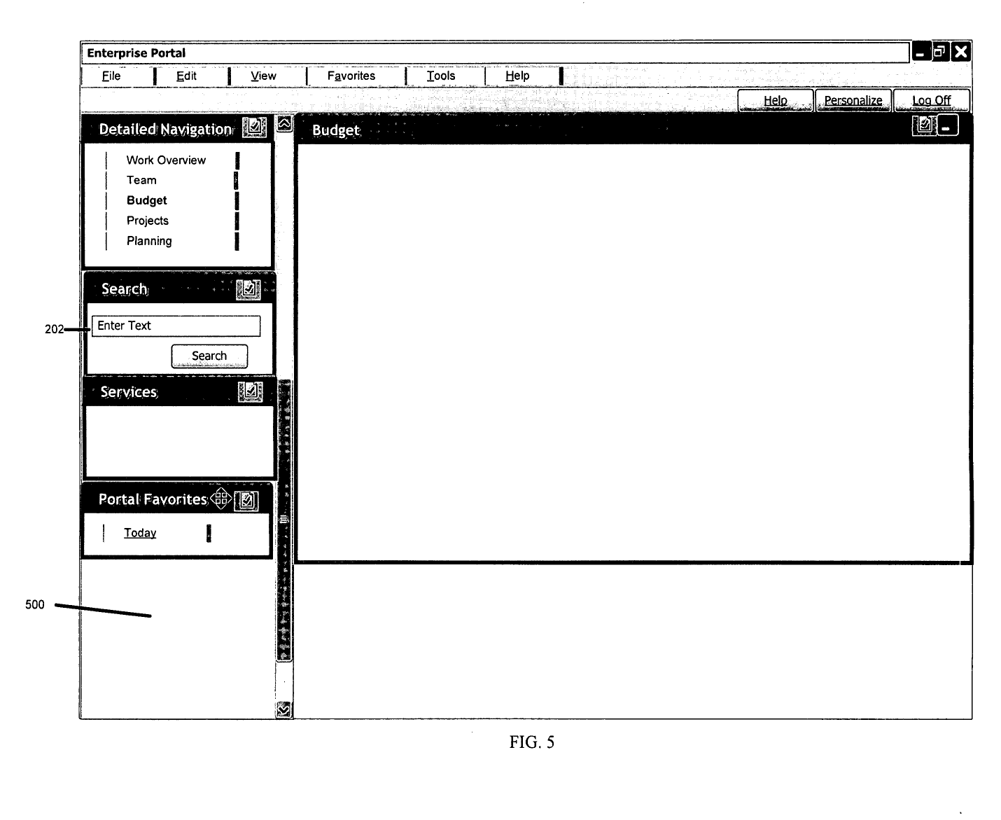

Alternatively, FIG. 5 depicts an example embodiment that automatically shifts the window panes vertically to eliminate the white space in-between window panes and keeps all the white space 500 at the bottom of the navigation panel.

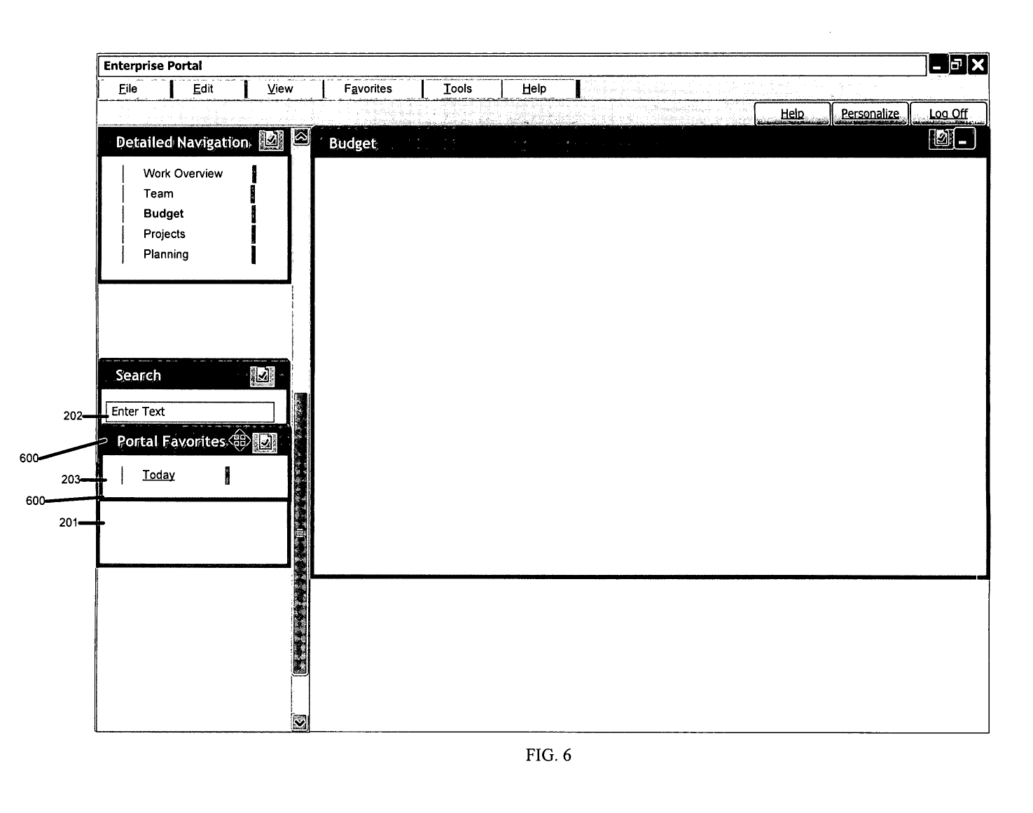

FIG. 6 depicts an example embodiment where a window pane, in this example the same portal favorites pane 203, is dragged to overlap 600 two other window panes 201 and 202 in the navigational panel.

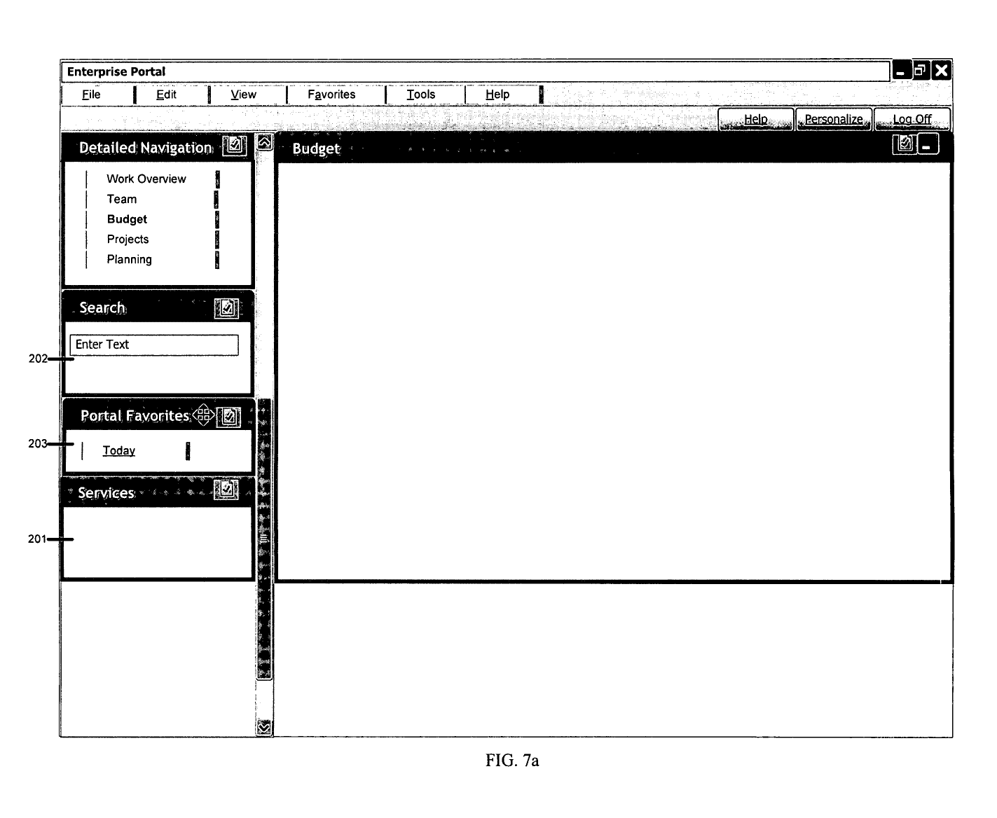

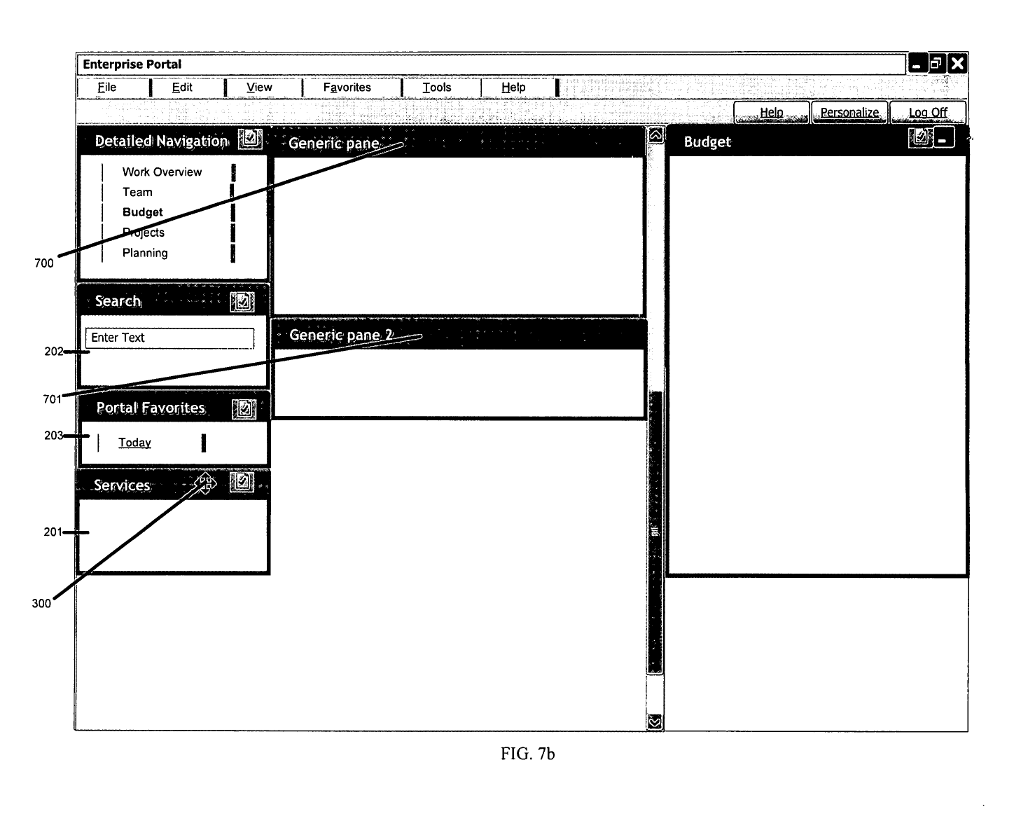

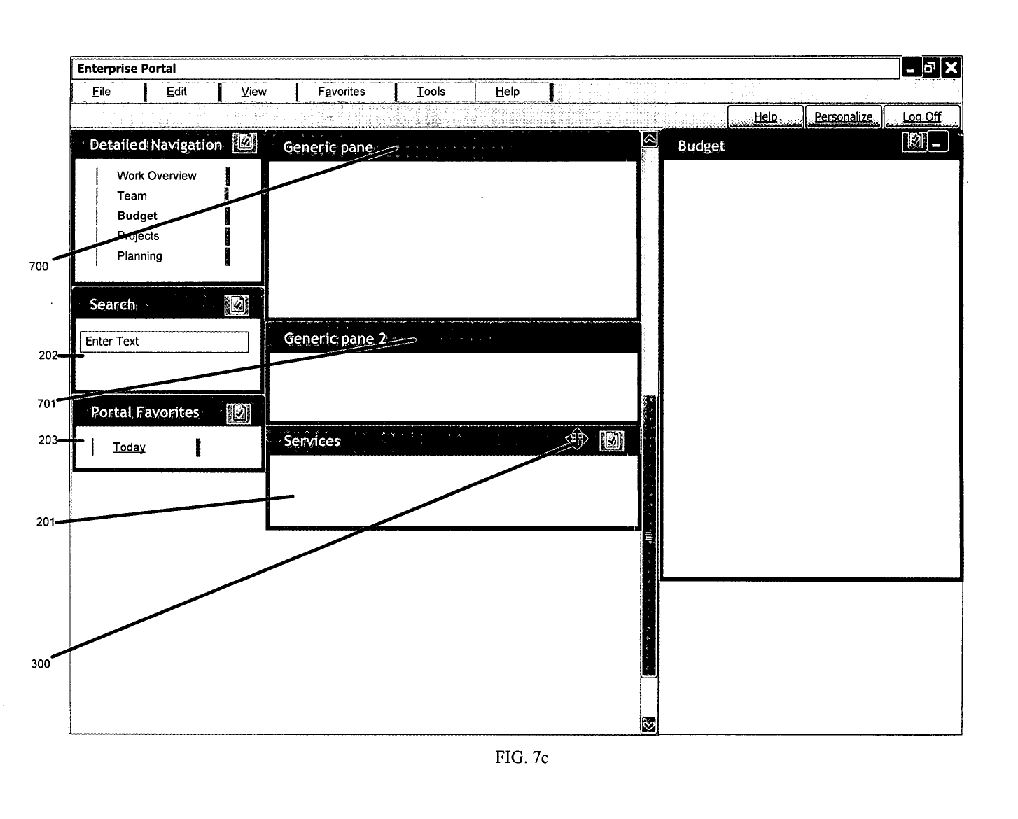

FIG. 7a depicts an example embodiment where the enterprise portal navigation panel automatically adjusts to shift the window panes 201 and 202 to eliminate overlap. The example embodiment of the enterprise portal would detect the location where the drag-and-dropped window pane was dropped. If the window pane is dropped between two other panes, as the portal favorites pane 203 is in the figure, the search pane 202 would be shifted up and the services pane 201 would be shifted down to make room for the portal favorites pane 203.

FIG. 7b depicts an alternative embodiment with horizontal drag-and-drop and automatic resizing. Alternative embodiments of the drag-and-drop windows may also allow for automatic resizing to match column width of surrounding window panes. For example, the navigation panel in FIG. 7b contains two columns, the right column containing example generic window panes 700 and 701 being wider than the left column panes 201, 202, etc. If a left column pane, such as the services pane 201, were to be moved by a cursor 300 over to the right column, not only would the window panes shift to eliminate white space, but also to align with the right column the window pane may also resize the window to match the width of the right column.

FIG. 7c depicts a window pane that is resized after it has moved horizontally to match with the width of another pane. The services pane 201 that was previously narrow, widens in the second column to match the width of other window panes 700 and 701 in the same column. In alternative embodiments, if there is no set column width between columns, the resize may not be automatic.

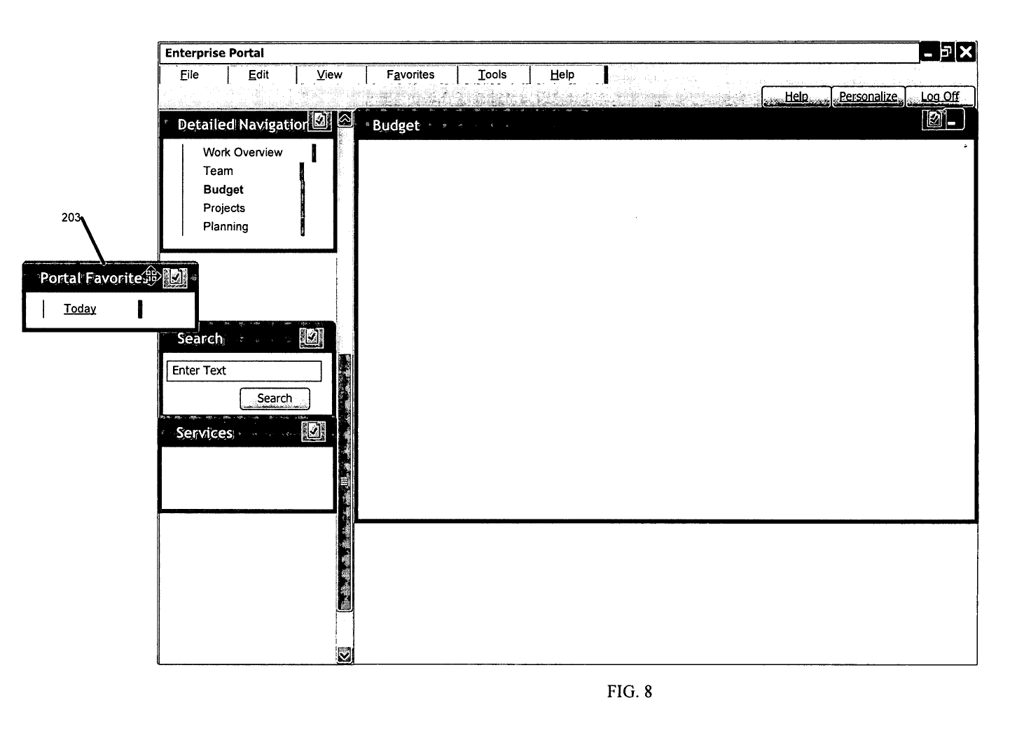

FIG. 8 depicts an example embodiment where a window pane can be “hidden” if the window pane is dragged outside of the navigation panel region. The example embodiment detects that a significant portion of the portal favorites pane 203 is outside of the navigation panel. Alternatively, the embodiment could detect that the cursor is outside of the portal to indicate that a window pane should be hidden. When the portal detects that a user moves a pane to be hidden, the portal favorites pane 203 disappears from the navigation panel and is “hidden” until it is re-selected to be viewed by user in a menu.

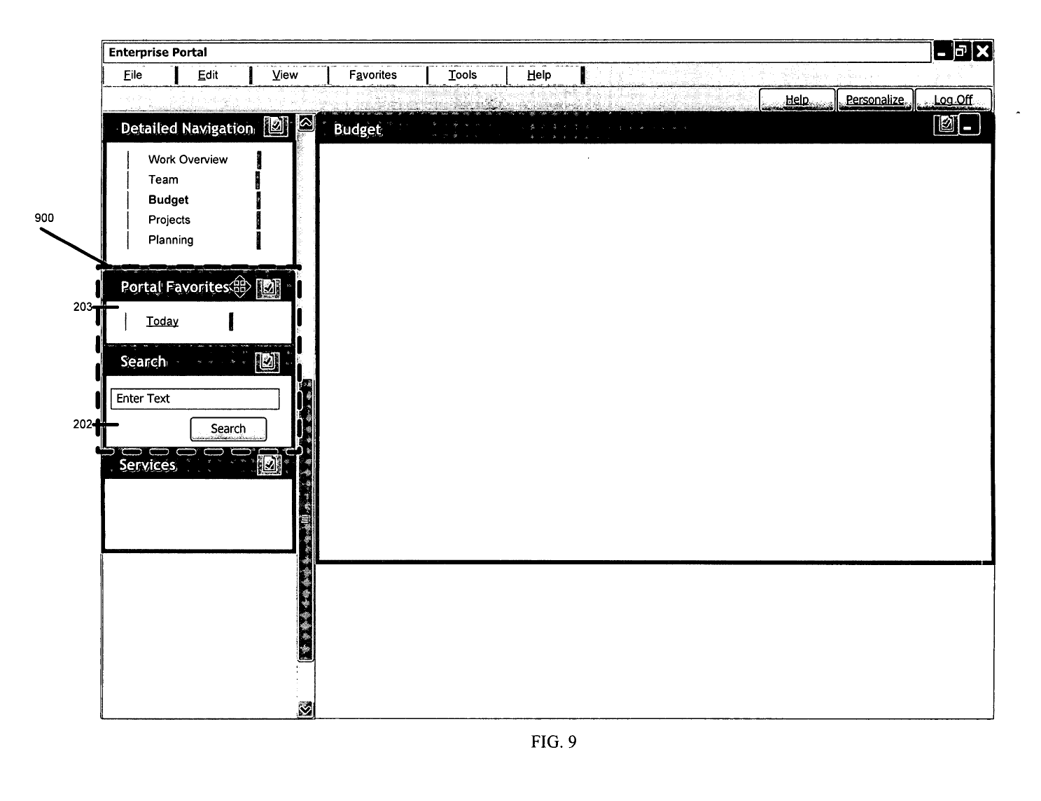

FIG. 9 depicts an example embodiment where multiple panes can be drag-and-dropped.

Multiple panes may be selected by various methods, such as by holding the “control” button, by dragging the cursor and selecting multiple panes, etc. When multiple panes are selected, the group 900 of panes can be drag-and-dropped, acting like a single pane, and moved around the navigation panel.

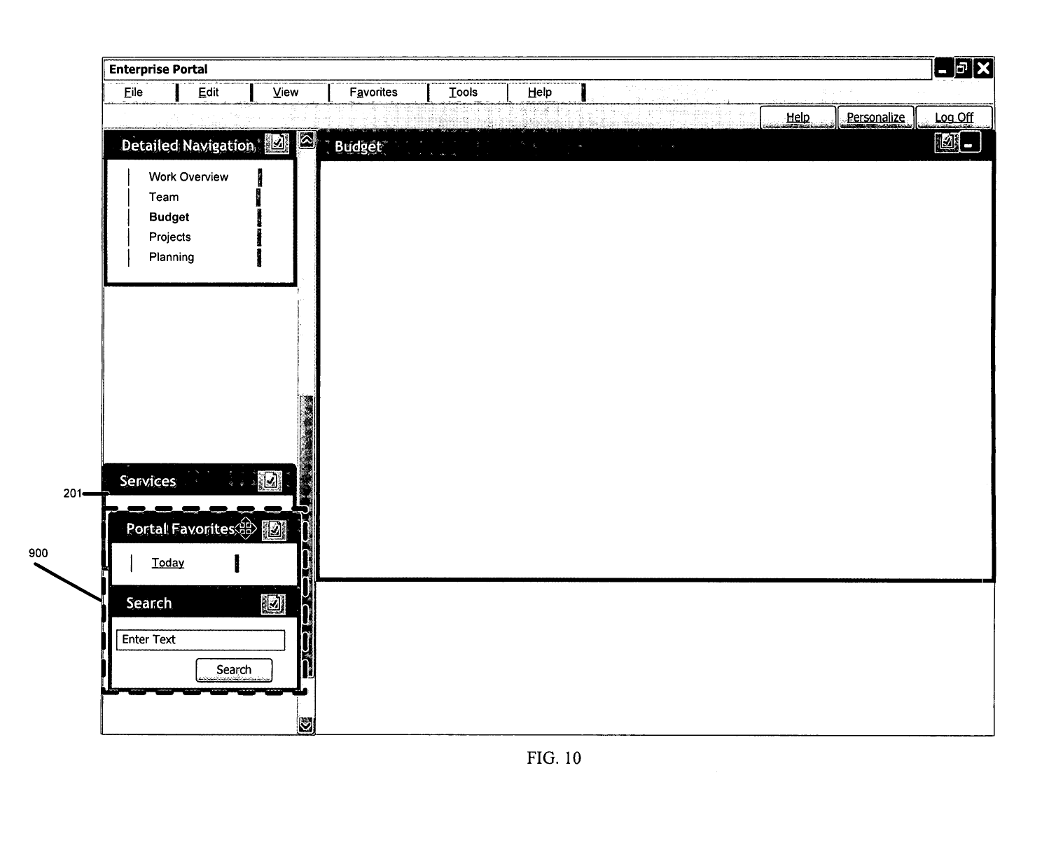

FIG. 10 depicts the multiple panes dragged to overlap another pane. In this example, the group acts as a single pane and the new location for the group may be determined where the cursor is released.

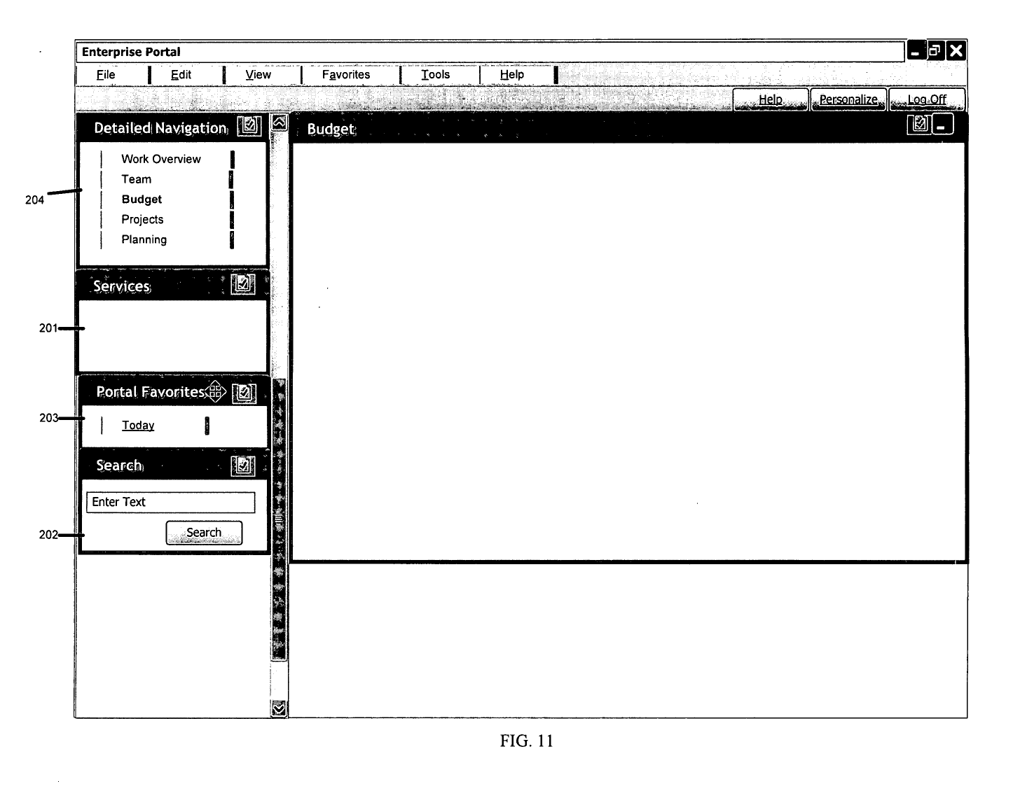

FIG. 11 depicts an embodiment where the panes automatically shift panes to eliminate horizontal and vertical white space. In this example, because the group had exceeded the top of the services pane 201 in FIG. 10, the services pane 201 is shifted up under the detailed navigation pane 204 and the group of panes is shifted to eliminate the white space between the group of panes and the services pane 201. Note that the order of the panes is kept in the same order that was originally grouped, with the portal favorites pane 203 directly above the search pane 202. In an alternative embodiment, if control click is used to select multiple panes that are not contiguous, the order of the panes may be kept the same but the panes may still be shifted to eliminate white space.

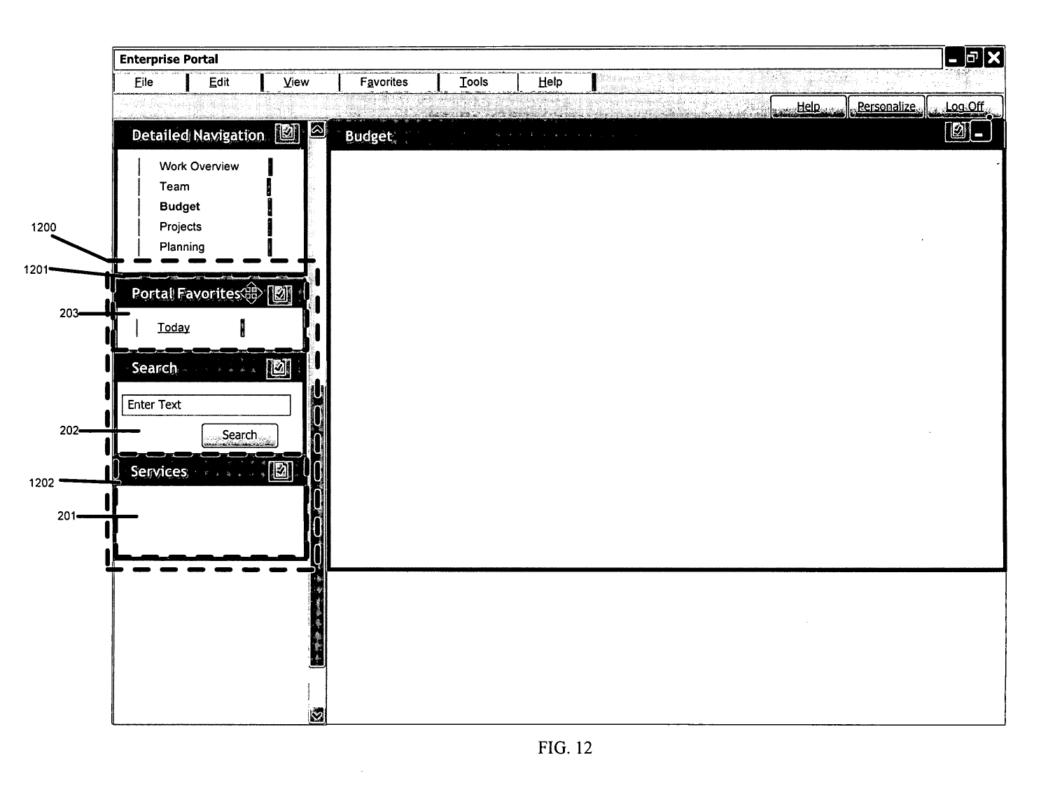

FIG. 12 depicts an example embodiment where the panes that are selected are not contiguous. The group of panes 1200 highlights the two panes that are selected 1201 and 1202 by highlighting the panes within the large group highlight 1200 that are selected, 203 and 201, respectively. Again the group of panes 1200 is dragged as a group.

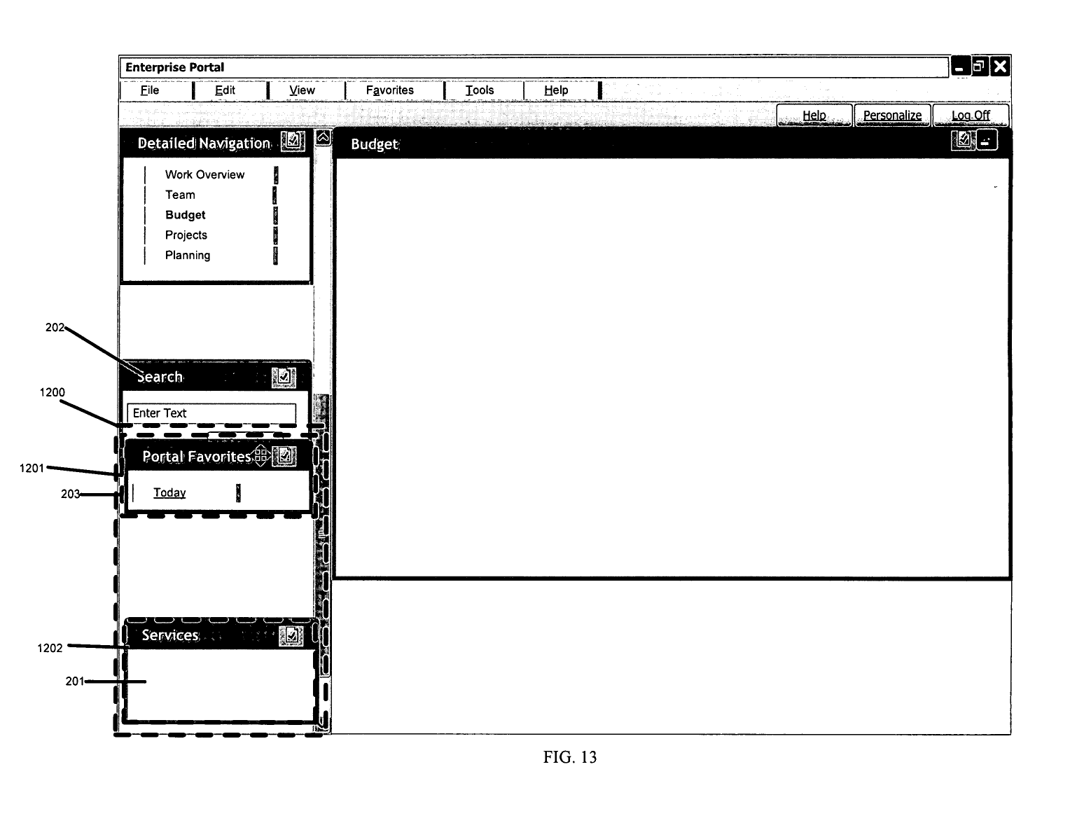

FIG. 13 depicts an example embodiment where the group of panes is shifted down below another pane. While dragged the appearance remains the same, with a space in-between panes 201 and 203.

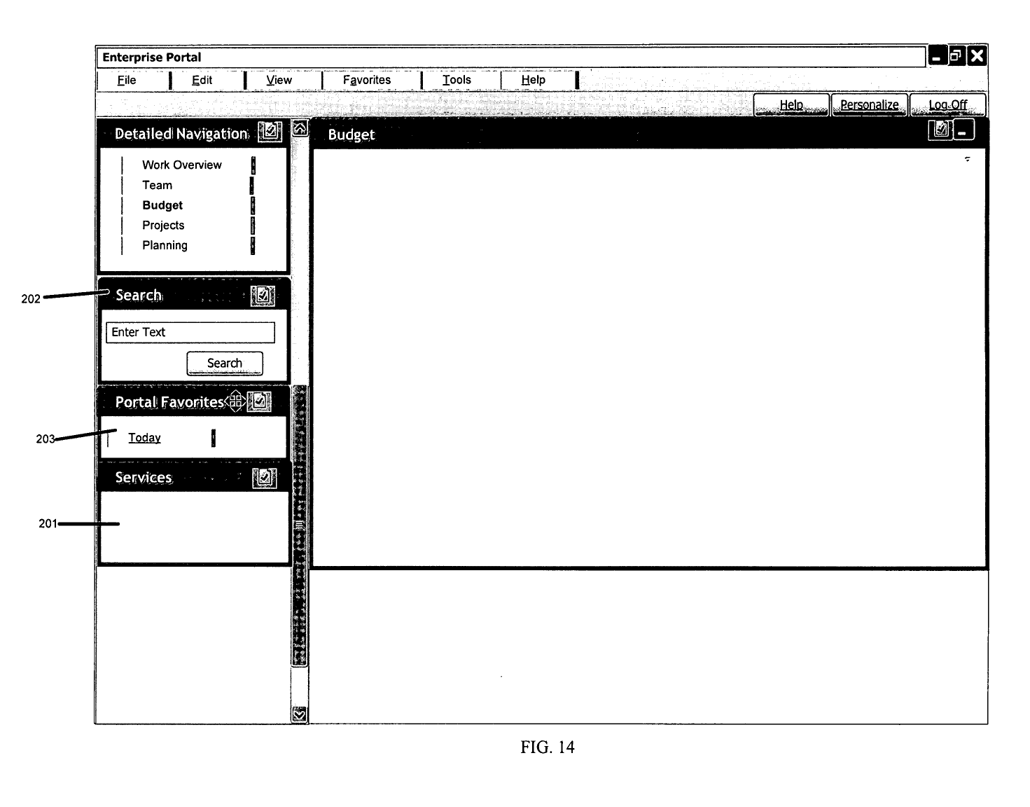

FIG. 14 depicts an embodiment where the navigation panel automatically eliminates the white spaces appearing between the panes. Like in FIG. 11, the order of the panes is kept the same with pane 203 above that of pane 201; however, the white space between panes 203 and 201 is eliminated, just like the white space between that of panes 203 and 202.

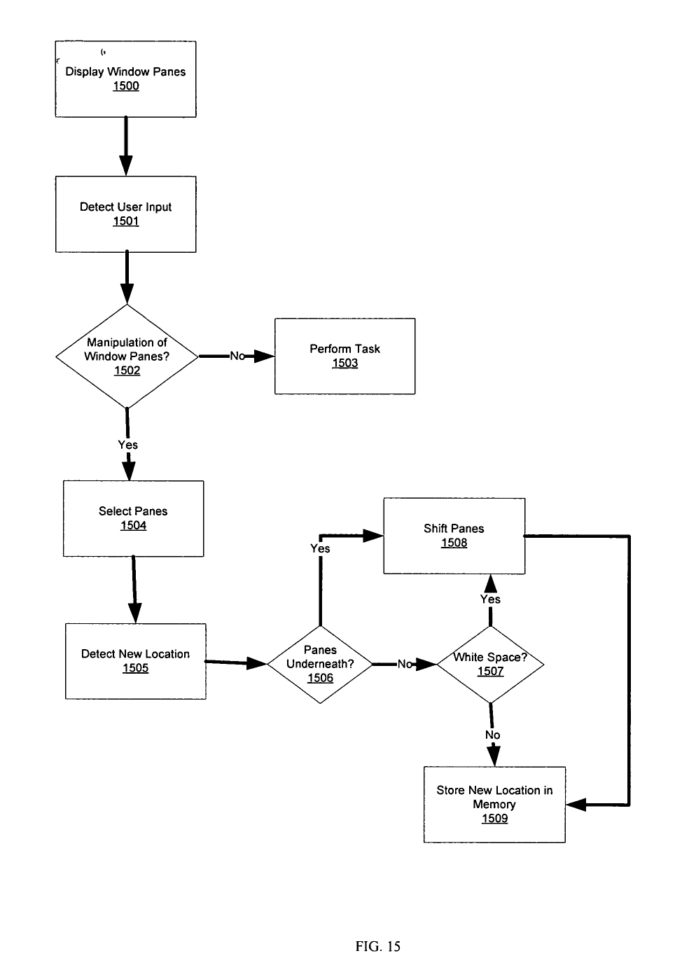

FIG. 15 depicts an example logic that may be used to implement an embodiment of the present invention. An enterprise portal displays all of the window panes 1500, either in the main content windows, the navigation panel, or any other panels in the portal. The enterprise portal awaits a user input 1501. If a user input is detected, the embodiment must determine whether it is an input to manipulate the window pane locations 1502 or to perform an alternate enterprise portal task, such as an embedded functionality task within a window pane. If the input is to perform a task in a window pane, then the task is performed 1503. If the input is to manipulate the location of the window pane then the input first determines the panes that are selected 1504, either singular or multiple, and also determines the structure and ordering of the panes within the group of panes. The user drag-and-drops the pane or group of panes and when the user decides on a new location, the new location of the panes is determined 1505. In some embodiments that eliminate white space or overlap, the embodiment determines if there are panes underneath the moved panes 1506. If there are panes underneath, the panes underneath are shifted 1508 and the new locations of all the panes are stored 1509. Otherwise, the enterprise portal detects whether there is excess white space 1507. If there is excess white space the panes are shifted 1508 and the new locations of all the panes are stored 1509. When the locations are stored, they can be stored either for that particular user or for the specific role that represents the user's position.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method comprising:
displaying an enterprise portal;
displaying a navigation panel in the enterprise portal, wherein the navigation panel has at least one window pane;
detecting a first position of a first window pane;
detecting an input signal to drag-and-drop the first window pane to a second position; and
displaying the first window pane in the second position.

2. A method according to claim 1, wherein the window pane is an iView.

3. A method according to claim 1, wherein the window pane displays data content.

4. A method according to claim 3, wherein the data content is business data.

5. A method according to claim 1, wherein the window pane contains an embedded functionality.

6. A method according to claim 5, wherein the embedded functionality processes business data.

7. A method according to claim 5, wherein the embedded functionality is providing navigation links.

8. A method according to claim 5, wherein the embedded functionality is links to run applications in a new window.

9. A method according to claim 5, wherein the embedded functionality is displaying portal favorites.

10. A method according to claim 5, wherein the embedded functionality is searching the enterprise portal.

11. A method according to claim 1, further comprising selecting multiple window panes.

12. A method according to claim 11, further comprising detecting an input signal to drag-and-drop the multiple window panes to a second position.

13. A method according to claim 1, further comprising hiding the window pane where the second position is outside the display of the navigation panel.

14. A method according to claim 1, further comprising shifting window panes that overlap with the second position of the first window pane.

15. A method according to claim 1, further comprising shifting the first window pane in the second position to a third position to close out white space.

16. A method according to claim 1, further comprising automatically resizing a first window pane to match a second window pane.

17. A method according to claim 1, wherein the second position is located substantially horizontal away from the first position.

18. A method according to claim 1, further comprising storing into memory the locations of the window panes in the navigation panel.

19. A method according to claim 18, wherein the stored locations in memory are attributed to a specific user.

20. A method according to claim 18, wherein the stored locations in memory are attributed to a specific role.

21. A graphical user interface for display on a display unit of a processor-based device, comprising:
an enterprise portal; and
a navigation panel displayed in the enterprise portal, wherein the navigation panel has at least one window pane having a first position, wherein the at least one window pane can undergo a drag-and-drop movement from the first position to a second position in the display unit.

22. A graphical user interface according to claim 21, wherein the window pane is an iView.

23. A graphical user interface according to claim 21, wherein the window pane displays data content.

24. A graphical user interface according to claim 23, wherein the data content is business data.

25. A graphical user interface according to claim 21, wherein the window pane contains an embedded functionality.

26. A graphical user interface according to claim 25, wherein the embedded functionality processes business data.

27. A graphical user interface according to claim 25, wherein the embedded functionality is providing navigation links.

28. A graphical user interface according to claim 25, wherein the embedded functionality is links to run applications in a new window.

29. A graphical user interface according to claim 25, wherein the embedded functionality is displaying portal favorites.

30. A graphical user interface according to claim 25, wherein the embedded functionality is searching the enterprise portal.

31. A graphical user interface according to claim 21, further comprising an input to select multiple window panes.

32. A graphical user interface according to claim 31, further comprising an input to drag-and-drop the multiple window panes to a second position.

33. A graphical user interface according to claim 21, wherein window panes are hidden on the navigation panel where the second position is outside the display of the navigation panel.

34. A graphical user interface according to claim 21, wherein window panes that overlap with the second position of the first window pane are shifted.

35. A graphical user interface according to claim 21, wherein the first window pane is shifted from the second position to a third position to close out white space.

36. A graphical user interface according to claim 21, wherein the first window pane is automatically resized to match a second window pane.

37. A graphical user interface according to claim 21, wherein the second position is located substantially horizontal away from the first position.

38. A graphical user interface according to claim 21, further comprising a memory to store the locations of the window panes in the navigation panel.

39. A graphical user interface according to claim 38, wherein the stored locations in memory are attributed to a specific user.

40. A graphical user interface according to claim 38, wherein the stored locations in memory are attributed to a specific role.

41. A computer readable medium containing instructions that when executed result in a performance of a method comprising:
displaying an enterprise portal;
displaying a navigation panel in the enterprise portal, wherein the navigation panel has at least one window pane;
detecting a first position of a first window pane;
detecting an input signal to drag-and-drop the first window pane to a second position; and
displaying the first window pane in the second position.

42. A system comprising:
an arrangement for displaying an enterprise portal;
an arrangement for displaying a navigation panel in the enterprise portal, wherein the navigation panel has at least one window pane;
an arrangement for detecting a first position of a first window pane;
an arrangement for detecting an input signal to drag-and-drop the first window pane to a second position; and
an arrangement for displaying the first window pane in the second position.
